(19) United States
(12) Patent Application Publication
(10) Pub. No.: US 2009/0127951 A1
(43) Pub. Date: May 21, 2009

(54) MAGNETIC PROPULSION DEVICE

(76) Inventor: Masayoshi SHIBANO, Kashiwazaki-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 11/943,863

(22) Filed: Nov. 21, 2007

(51) Int. Cl. H02K 7/06; H02N 11/00

(52) U.S. Cl. 310/80; 415/916

(57) ABSTRACT

An object of the present invention is to provide a hitherto unknown, innovative magnetic propulsion device that can provide free magnetic propulsion through a geomagnetic field or another space in which a uniform magnetic field (B) is present by using an interaction with the uniform magnetic field (B). The magnetic propulsion device is configured such that wing rotors (2), which have an electromagnet (2a) wherein the upper side of the two poles therein is magnetically sealed, and which generate a magnetic field (A) toward the downward side of the two magnetic poles, are provided in an axially rotatable manner to an airframe (1) by way of an axial rotation mechanism (3). The rate and direction of the electric current that flows to the electromagnet (2a) is adjustable. The magnetic flux direction of the magnetic field (A) is reversible. The airframe (1) is held in a state of being prevented from rotating horizontally or obliquely. The magnetic field (A) generated from the wing rotors (2) is rotatably configured with respect to the uniform magnetic field (B) outside the airframe (1). The rotation of the magnetic field (A) in relation to the uniform magnetic field (B) generates a Lorentz force that causes the airframe (1) to be magnetically propelled.

### BACKGROUND OF THE INVENTION

1. Field of the Invention

The present invention relates to a magnetic propulsion device configured so as to be capable of magnetically propelling a body with the aid of the Lorentz force.

2. Description of the Related Art

Conventionally, a magnetic propulsion device has been proposed having a configuration in which an airframe is lifted and propelled by an electromagnetic interaction.

A linear motor car, for example, has a configuration in which a large number of superconductive magnets is provided to an airframe, and the airframe is caused to slightly float above the ground and is propelled and made to travel with the aid of the electromagnetic interaction between a magnetic field produced by the superconductive magnet and the magnetic field produced by a coil provided to the rail.

In this manner, a conventional magnetic propulsion device requires not only an airframe, but also a special magnetic field generator to produce a magnetic field (e.g., the rail-side magnetic field noted above) toward the airframe for airframe propulsion.

Conventionally, there is yet to be proposed an excellent device that requires no special magnetic field generator for generating a magnetic field toward the airframe for airframe propulsion, and for being able to magnetically propel an airframe with the aid of the electromagnetic interaction between a magnetic field generated from the airframe side and, e.g., the geomagnetic field or another uniform magnetic field that is already present outside of the airframe.

The present invention was perfected as a result of many years of research by the present applicant, and an object thereof is to provide a hitherto unknown, highly innovative magnetic propulsion device that has excellent practicality in terms of not requiring any special device for generating a magnetic field toward the airframe in order to propel the airframe, and that magnetically propels the airframe with the aid of the electromagnetic interaction between the magnetic field produced from the airframe side and, e.g., the geomagnetic field or another uniform magnetic field that is already present outside of the airframe, and that can freely magnetically propel an airframe as long as the airframe is present in the uniform magnetic field.

### SUMMARY OF THE INVENTION

The main points of the present invention will be described with reference to the accompanying drawings.

A first aspect of the present invention provides a magnetic propulsion device, wherein a wing rotor 2, which has an electromagnet 2a and which generates a magnetic field A toward a lower side of both of two magnetic poles of the electromagnet 2a while an upper side of both magnetic poles is magnetically sealed, are provided in an axially rotatable manner to an airframe 1 via an axial rotation mechanism 3. The amount and direction of electric current flowing to the electromagnet 2a are adjustable. The magnetic flux direction of the magnetic field A is reversible. The airframe 1 is held in a state in which horizontal rotation is restrained. The magnetic field A generated by the wing rotor 2 is able to rotate with respect to a uniform magnetic field B on an exterior of the airframe 1. The rotation of the magnetic field A in relation to the uniform magnetic field B generates a Lorentz force that magnetically propels the airframe 1.

A second aspect of the present invention is the magnetic propulsion device according to the first aspect, wherein nozzles 7 whereby the direction of the magnetic flux of the magnetic field A generated from the wing rotors 2 is restricted to a prescribed direction are provided to the wing rotors 2 or the airframe 1. A magnetic field space of the magnetic field A generated by the wing rotors 2 is prevented from spreading in the axial direction of the magnetic poles of the wing rotors 2. The shape of the nozzles 7 is determined so that the magnetic flux direction is restricted in a manner that causes the magnetic field space to spread downward and in a direction orthogonal to axes of the magnetic poles.

A third aspect of the present invention is the magnetic propulsion device according to the first or second aspect, wherein at least a single set of the wing rotors 2 is coaxially provided to the airframe 1. At least the single set of wing rotors 2 is configured to be capable of axial rotation in mutually opposite directions with respect to the airframe 1 via an axial rotation mechanism 3.

A fourth aspect of the present invention is the magnetic propulsion device according to the first or second aspect, wherein the electric current that flows to the electromagnet 2a of the wing rotor 2 is controlled when flowing to the electromagnet 2a so that the magnetic pole that rotates toward the N pole direction of the uniform magnetic field B on the exterior of the airframe is an N pole, and the magnetic pole that rotates toward the S pole direction is an S pole.

A fifth aspect of the present invention is the magnetic propulsion device according to the third aspect, wherein the electric current that flows to the electromagnet 2a of the wing rotor 2 is controlled when flowing to the electromagnet 2a so that the magnetic pole that rotates toward the N pole direction of the uniform magnetic field B on the exterior of the airframe is an N pole, and the magnetic pole that rotates toward the S pole direction is an S pole.

The present invention, as described above, is configured so that a magnetic field is generated from wing rotors provided to an airframe, and the magnetic field is made to rotate with respect to a uniform magnetic field outside of the airframe, whereby a Lorentz force is generated and the airframe is magnetically propelled. Therefore, a innovative magnetic propulsion device having excellent practicality is achieved in which an airframe can be freely magnetically propelled in a desired direction in various locations, examples of which include above the earth, as shall be apparent, in which the geomagnetism is present, but also outer space, in which the magnetic fields of celestial bodies are present.

### BRIEF DESCRIPTION OF THE DRAWINGS

FIG. 1 is an explanatory diagram of “the uniform magnetic field B and electric current” of the magnetic propulsion theory of the present example;

FIG. 2 is an explanatory diagram of “the uniform magnetic field B and electric current-induced spiral magnetic field” of the magnetic propulsion theory of the present example;

FIG. 3 is an explanatory diagram of the “combination of the uniform magnetic field B and electric current-induced spiral magnetic field” of the magnetic propulsion theory of the present example;

FIG. 4 is an explanatory diagram of the “surface area of the plane of a Lorentz force created by an electric wire” of the magnetic propulsion theory of the present example;

FIG. 5 is an explanatory diagram of the “poles of the electromagnet 2a of the wing rotor 2” according to the magnetic propulsion theory of the present example;

FIG. 6 is an explanatory diagram of the “strength of the magnetic field and the direction of the lines of magnetic force” according to the magnetic propulsion theory of the present example;

FIG. 7 is an explanatory diagram of the “triangle theorem” according to the magnetic propulsion theory of the present example;

FIG. 8 is an explanatory diagram of the “strength of the magnetic field and the direction of the lines of magnetic force” according to the magnetic propulsion theory of the present example;

FIG. 9 is an explanatory diagram of the “the size and shape of the magnetic field produced by the poles and balanced with the uniform magnetic field B (48.4 (A/m))” according to the magnetic propulsion theory of the present example;

FIG. 10 is an explanatory diagram of the “magnetic field A emitted while restricted by the magnetic seal part 6 and the nozzle 7 of the wing rotor 2” according to the magnetic propulsion theory of the present example;

FIG. 11 is an explanatory diagram of the “three-dimensional shape of the magnetic field space of the magnetic field A as balanced with the uniform magnetic field B” according to the magnetic propulsion theory of the present example;

FIG. 12 is a diagram showing the cross-section A-A of FIG. 11;

FIG. 13 is a diagram showing the surface area of the plane of the Lorentz force in side view of the FIG. 11;

FIG. 14 is an explanatory diagram of the “combination of the uniform magnetic field B and magnetic pole-induced magnetic field A” of the magnetic propulsion theory of the present example;

FIG. 15 is a view of FIG. 14 as seen from above;

FIG. 16 is a view of FIG. 14 as seen from the N direction;

FIG. 17 is an explanatory view of the “buoyancy of the combined magnetic fields” according to the magnetic propulsion theory of the present example;

FIG. 18 is an explanatory view of the “wing rotor 2” of the magnetic propulsion theory according to the present example;

FIG. 19 is an explanatory view of the “collision between a wall and an object” according to the magnetic propulsion theory of the present example;

FIG. 20 is an explanatory view of the “collision between a jet flow and a wall” according to the magnetic propulsion theory of the present example;

FIG. 21 is an explanatory view of the “rotation of the plane of the Lorentz force and the extended length of the lines of magnetic force of the uniform magnetic field B” according to the magnetic propulsion theory of the present example;

FIG. 22 is an explanatory view of the “plane of the Lorentz force related to the N pole that increases during rotation and the state of the extended lines of magnetic force of an external magnetic field” according to the magnetic propulsion theory of the present example;

FIG. 23 is an explanatory view of the “rotating plane of the Lorentz force” according to the magnetic propulsion theory of the present example;

FIG. 24 is a schematic front cross-sectional view of the magnetic propulsion device of the present example;

FIG. 25 is a schematic top cross-sectional view of the magnetic propulsion device of the present example;

FIG. 26 is a diagram showing a configuration of the axial rotation mechanism 3 of the magnetic propulsion device of the present example, in which the upper and lower wing rotors 2 are disposed so as to sandwich the gears 3b of the plurality of motors 3a, and in which the upper and lower wing rotors 2 are caused to rotate in opposite directions using the rotation drive of the motor 3a;

FIG. 27 is an exploded perspective view showing the configuration of the axial rotation mechanism 3 of the magnetic propulsion device of the present example;

FIG. 28 is a cross-sectional view showing the structure of the nozzle 7 and the distal end part of the wing rotors 2 of the magnetic propulsion device of the present example; and

FIG. 29 is a diagram showing the state of the magnetic propulsion device of the present example in flight.

### DESCRIPTION OF THE PREFERRED EMBODIMENTS

Embodiments of the present invention considered to be advantageous are briefly described, and the effects of the present invention are described with reference to the drawings.

An electromagnet 2a of a wing rotor 2 is provided in an axially rotatable manner to an airframe 1 via an axial rotation mechanism 3 in a space in which a uniform magnetic field B is present on the exterior of the airframe 1. When an electric current is sent through the electromagnet 2a, a magnetic field A is generated toward the lower side of the two poles of the electromagnet 2a because the upper side of the two poles of the electromagnet 2a is magnetically sealed.

In this case, if the magnetic seal is not applied to the electromagnet 2a and a magnetic field A is generated in the radial direction from the two poles of the electromagnet 2a, a Lorentz force is simultaneously generated in a completely opposite direction, and the forces mutually offset due to the interactive effect between the uniform magnetic field B and the magnetic field A extending in the radial direction. Concerning this point, in the present invention, a Lorentz force that is to be used to magnetically propel the airframe 1 in a prescribed direction is generated by the interactive effect of the two magnetic fields A and B because the upper side of the two poles of the electromagnet 2a is magnetically sealed and a magnetic field A is generated toward the downward side of the two poles.

Also, when the wing rotors 2 are made to rotate with respect to the airframe 1 when the magnetic field A is generated, the magnetic field A generated by the wing rotors 2 is also caused to rotate with respect to the airframe 1.

In other words, the magnetic field A generated by the wing rotors 2 will rotate with respect to the uniform magnetic field B.

In this manner, the wing rotors 2 do not merely generate a magnetic field A with respect to the uniform magnetic field B and create a Lorentz force, but the magnetic field A generated by the wing rotors 2 is caused to rotate with respect to the uniform magnetic field B, and the lines of magnetic force of the uniform magnetic field B are sequentially extended by the rotating magnetic field A, whereby a Lorentz force of a greater magnitude is generated, and a magnetic propulsion force is imparted to the airframe 1 in an amount commensurate therewith.

There is a problem in that the direction of the Lorentz force inverts in accordance with the rotation of the magnetic field A when a Lorentz force is generated while the magnetic field A is rotated with respect to the uniform magnetic field B in this manner. Concerning this point as well, the present invention is configured to be capable of adjusting the rate and direction of the electric current that flows to the electromagnets 2a of the wing rotors 2, and the direction of the electric current is therefore reversed and the direction of the magnetic flux of the magnetic field A that is generated by the wing rotors 2 is inverted, whereby the direction of the Lorentz force can be invertibly controlled as desired, and the inversion of the Lorentz force can be suitably handled.

Therefore, according to the present invention, the magnetic field A generated by the wing rotors 2 is made to rotate with respect to, e.g., the geomagnetism or another type of uniform magnetic field B, whereby the airframe 1 is magnetically propelled in a prescribed direction. Therefore, a innovative magnetic propulsion device having excellent practicality is achieved in which an airframe can be freely magnetically propelled in a desired direction in various locations, examples of which include above the earth, as shall be apparent, in which the geomagnetism is present, but also outer space, in which the magnetic fields of celestial bodies are present, and in other spaces in which a uniform magnetic field B is present.

For example, nozzles 7 for restricting the direction of the magnetic flux of a magnetic field A generated from the wing rotors 2 in a prescribed direction are provided to the wing rotors 2 or the airframe 1, a magnetic field space of the magnetic field A generated from the wing rotors 2 is prevented from spreading in the axial direction of the magnetic poles of the wing rotors 2, and the nozzle shape of the nozzles 7 is determined so that the magnetic flux direction is restricted in a manner that causes the magnetic field space to spread downward and in a direction orthogonal to the axes of the magnetic poles. Such a configuration expands the active plane of the magnetic field A, which stretches the lines of magnetic force of the uniform magnetic field B and generates a large Lorentz force as the lines of magnetic force of the uniform magnetic field B are stretched in the manner described above. Therefore, the magnetic field A generated by the wing rotors 2, wherein the magnetic flux direction is restricted by the nozzles 7, allows an even greater Lorentz force to be generated when rotated with respect to the uniform magnetic field B, and the airframe 1 can be magnetically propelled in a suitable manner commensurate with the greater Lorentz force.

At least a single set of the wing rotors 2 is coaxially provided to the airframe 1, and at least the single set of wing rotors 2 is configured to be capable of axial rotation in mutually opposite directions with respect to the airframe 1 via an axial rotation mechanism 3. In the case of such a configuration, the single set of wing rotors 2 in which the axial rotational directions are in the opposite directions generate a magnetic field A in an alternating fashion and generate a Lorentz force in an alternating fashion. Rotating repulsive forces in which the rotational directions are in the forward and reverse opposite directions are thereby imparted to the airframe 1 in an alternating fashion even if a rotating repulsive force were to be imparted to the magnetic field A and a rotating repulsive force were to be imparted to the airframe 1. Therefore, the problem in which the airframe 1 itself is rotated about the axis thereof in a prescribed direction by the rotating repulsive force is not liable to occur, and the airframe 1 can be magnetically propelled with equivalent good stability.

Electric current that flows to the electromagnets 2a of the wing rotors 2 is controlled so that the magnetic pole that rotates toward the N pole direction of the uniform magnetic field B outside the airframe 1 is an N pole, and the magnetic pole that rotates toward the S pole direction is an S pole, when electric current flows to the electromagnets 2a. In such a configuration, the direction of the Lorentz force generated by the interactive effect between the magnetic field A produced by the wing rotors 2 and the uniform magnetic field B outside the airframe 1 can be reliably directed in the same direction, and the airframe 1 can be magnetically propelled in a prescribed direction in an even more suitable manner.

### EXAMPLES

First, the magnetic propulsion theory of the present invention will be described in detail.

### (Part 1: Mechanism for Generating Buoyancy and Buoyancy Magnitude)

### “1 Properties of Lines of Magnetic Force”

(1) Imaginary lines of magnetic force will be used to describe phenomena in a magnetic field.
(2) A magnetic field is a space through which lines of magnetic force pass.

(3) Lines of magnetic force start at the N pole and terminate at the S pole.

(4) Lines of magnetic force do not have a beginning or an end, and are in a constant closed curve.
(5) Lines of magnetic force have tension that makes them tend to contract in the same manner as stretched rubber.
(6) The tangent of the curve of the lines of magnetic force indicates the direction of the magnetic field at that point.
(7) The magnetic flux density in the magnetic field is thought to have H (number of) lines of magnetic force per unit (m²) of surface area in a location having a magnetic field strength of H(A/m).
(8) Lines of magnetic force never cross, branch, scatter, or disappear.
(9) The force of attraction that works between the differing N and S poles depends on the tension that attempts to contract the lines of magnetic force.
(10) The repulsive force between like poles is a force that operates so that they move away from each other as a result of the lines of magnetic force avoiding intersection and repelling each other.
(11) The lines of magnetic force that originate at point magnetic poles radially spread in all directions, i.e., 360°.

### “2 Geomagnetism and the Magnetic Fields of Celestial Bodies”

### A. Geomagnetism

(1) The magnitude of the geomagnetic dipole is 1.1×10¹⁷ (Wb/m)

(2) The horizontal component in the vicinity of Honshu, Japan is 30=2 (A/m) and the vertical component is 38±5 (A/m). Therefore, a magnetic field of 48.4 (A/m) exists at an inclination of 50°.

### “3 Magnetic Body”

Substances can be classified by their magnetic properties into three groups, i.e., diamagnetic materials, paramagnetic materials, and ferromagnetic materials.

### “4 Magnetic Permeability and Relative Magnetic Permeability”

### (A) The Magnetic Permeability of Substances

A magnetic flux density of B=μ₀·H (Wb/m²) is generated in air when a magnetizing force (magnetic field intensity) H(A/m) is applied. A magnetic flux density of B=μ₀·μ_{S}·H (Wb/m²) is generated when a magnetic body is placed in this magnetic field.

The ratio between the magnetic flux density and the magnetizing force is calculated. This is referred to as the magnetic permeability of a magnetic body, and is expressed as μ(H/m)

$$μ = {μ}_{0} \cdot {μ}_{S} = \frac{B}{H} \\ ∴ B = {μ}_{0} \cdot {μ}_{S} \cdot H \\ {μ}_{S} = \frac{μ}{{μ}_{0}} \qquad [ Formula 1 ]$$

μ₀ (H/m)=magnetic permeability of vacuum

=4·π×10⁻⁷

μ_{S} (absolute number)=relative magnetic permeability
B(Wb/m²)=magnetic flux density
H(A/m)=magnetizing force (magnetic field intensity)

### (B) Relative Permeability of Substances

The relative permeability μ_{S} (absolute number) expresses the ease with which a magnetic flux passes through a substance in comparison with a vacuum (the degree of ease with which a magnetic flux passes)

Relative permeability in a vacuum is 1, is substantially equal to 1 in air, and is considerably greater than 1 in a magnetic material.

The relative permeability μ_{S} of substances is listed in TABLE 1 below.

TABLE 1

| | | | | Density |
|---|---|---|---|---|
| Substance | μₛ | Substance | μₛ | (Kg^{W}/m³) |
| Hydrogen | 1 to 0.208 × 10⁻⁸ | Pure iron | 7,000 | 7,880 |
| Argon | 1 to 0.945 × 10⁻⁸ | Silicon steel | 7,000 | 7,650 |
| Water | 0.9999912 | Alperm | 40,000 | 6,500 |
| Air | 1.0000000365 | 78 Permalloy | 10,000 | 8,600 |
| Oxygen | 1.0000179 | Supermalloy | 1,000,000 | 8,720 |
| Aluminum | 1.0000214 | Mu-metal | 100,000 | 8,580 |
| Copper | 0.9999906 | | | |
| Silver | 0.9999736 | | | |

### 5 Lorentz Force

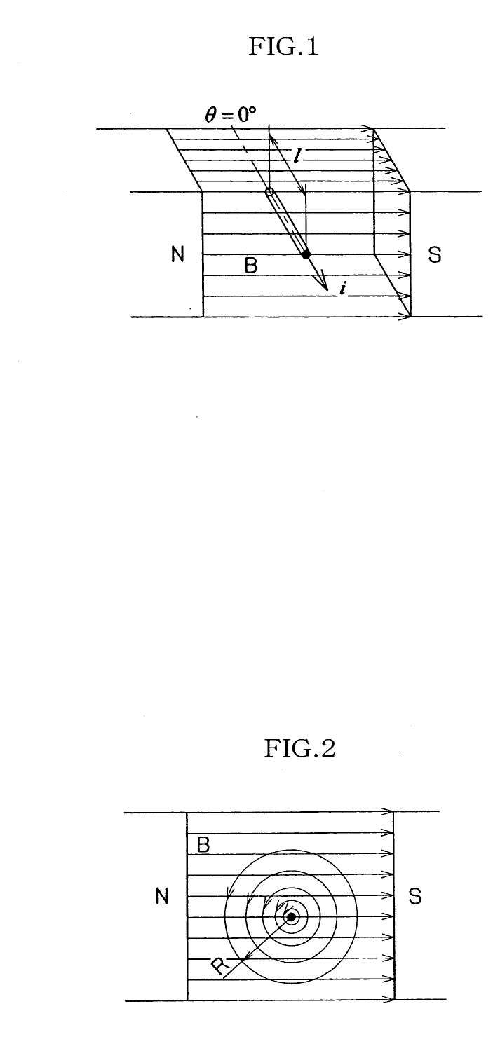

In FIG. 1, if an electric wire is placed in a uniform magnetic field B having a magnetic flux density of B(Wb/m²) and an electric current i (A) is sent through the wire, a spiral magnetic field produced by the electric current is generated in the manner shown in FIG. 2 by Ampere's right-hand rule.

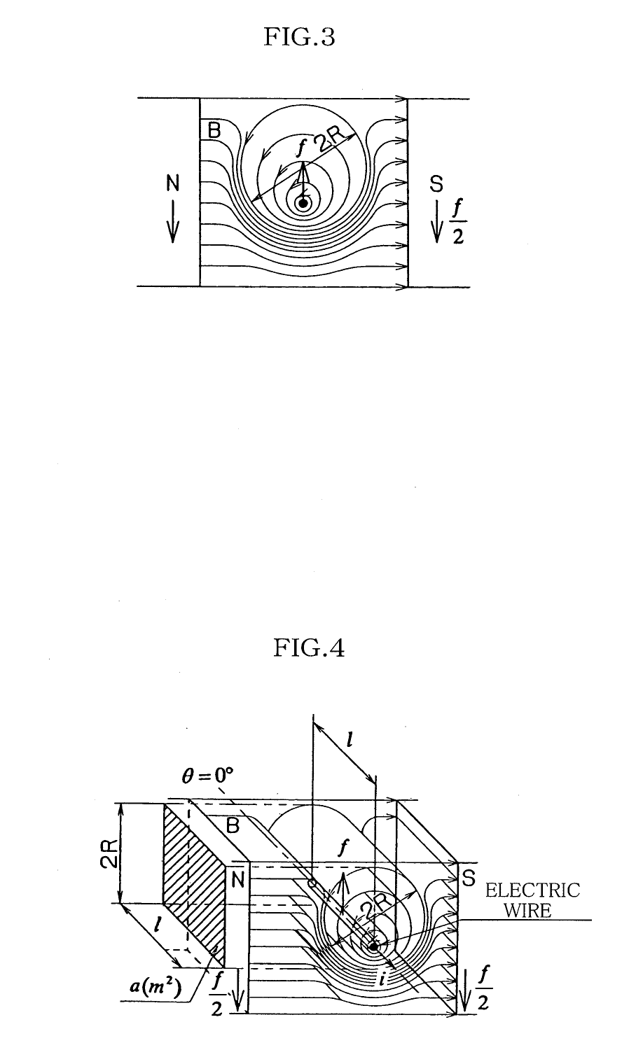

These two magnetic fields interact and combine, and the lines of magnetic force change in the manner indicated in FIG. 3.

On the lower side of the electric wire, the magnetic field of the electric current pulls the lines of magnetic force of the uniform magnetic field B to the lower side because the direction of the magnetic fields is the same, and the intermixing of the magnetic fields (lines of magnetic force) intensifies. On the other hand, since the direction of the magnetic fields is opposite above the electric wire, the magnetic fields (lines of magnetic force) are separated and weakened by an amount commensurate with the degree to which the lines of magnetic force of the uniform magnetic field B are attracted by the magnetic field of the electric current to the lower side. This shows that when a magnetic field encounters another magnetic field, intersection or intermixing with the counterpart magnetic field never occurs and the encounter has a characteristic in which the magnetic fields advance in the same direction while the magnetic fields repel each other in locations in which the intensity of the magnetic fields are balanced. The strong magnetic field on the lower side attempts to return to the original uniform magnetic field B and pushes upward the spiral magnetic field produced by the electric wire.

A buoyant force f that pushes upward thereby operates on the electric wire. This is referred to as Lorentz force and is well known in general electric theory as Fleming's left-hand rule.

The magnitude of Lorentz force f (N) is calculated in the manner described below (Formula 2).

$$f = B \cdot i \cdot l \cdot cos θ \\ \begin{matrix}B ( Wb / {m}^{2} ) = magnetic flux density \\ = {μ}_{0} \cdot {μ}_{S} \cdot H\end{matrix} \\ i ( A ) = electric current \\ l ( m ) = length of the electric wire in \\ the magnetic field \\ θ ( ° ) = angle between the \\ magnetic field and the electric wire \qquad [ Formula 2 ]$$

### “6 Surface Area of the Acting Surface for the Electric Wire to Achieve a Buoyancy of Lorentz Force of 1(N)”

The effect surface area a(m²) for the electric wire to achieve a buoyancy of Lorentz force f=1(N) is calculated from the geomagnetic uniform magnetic field H=48.4 (A/m).

First, the radius R (m) to the plane at which the intensity of the spiral magnetic field produced by the electric current comes into balance with the geomagnetic uniform magnetic field H=48.4 (A/m) is derived from Ampere's rule H=i/2·π·R and is noted below (Formula 3).

$$\begin{matrix}R = \frac{i}{2 \cdot π \cdot H} \\ = \frac{10000}{2 \cdot π \times 48.4} \\ = 32.9 ( m )\end{matrix} \\ \begin{matrix}i ( A ) = electric current \\ = 10 \text{,} 000 ( A )\end{matrix} \\ \begin{matrix}H ( A \text{/} m ) = geomagnetic uniform magnetic field \\ = 48.4 ( A \text{/} m )\end{matrix} \qquad [ Formula 3 ]$$

The length of the electric wire l (m) is derived from the formula F=B·i·1·cos θ (θ=0°) and is noted below (Formula 4).

$$\begin{matrix}l = \frac{f}{B \cdot i \cdot cos θ} \\ = \frac{f}{{μ}_{0} \cdot {μ}_{s} \cdot H \cdot i \cdot cos 0 °} \\ = \frac{1}{4 \cdot π \times {10}^{- 7} \times 1 \times 48.4 \times 10000 \times 1} \\ = 1.644 ( m )\end{matrix} \\ \begin{matrix}B ( Wb \text{/} {m}^{2} ) = magnetic flux density \\ == {μ}_{0} \cdot {μ}_{S} \cdot H\end{matrix} \\ \begin{matrix}{μ}_{0} ( H \text{/} m ) = magnetic permeability of vacuum \\ = 4 \cdot π \times {10}^{- 7}\end{matrix} \\ f ( N ) = 1 ( N ) \qquad [ Formula 4 ]$$

In FIG. 4, the lines of magnetic force of the uniform magnetic field are attracted in the direction of the magnetic field of the electric current from the height of 2R of the magnetic field of the electric current. Therefore, the acting surface area a(m²) in order to achieve a Lorentz force f=1 (N) is calculated in the following manner (Formula 5).

$$\begin{matrix}a = 2 \cdot R \cdot l \\ = 2 \times 32.9 \times 1.644 \\ = 108.2 ( {m}^{2} )\end{matrix} \qquad [ Formula 5 ]$$

“7 The Magnetic Poles of the Electromagnet 2a”

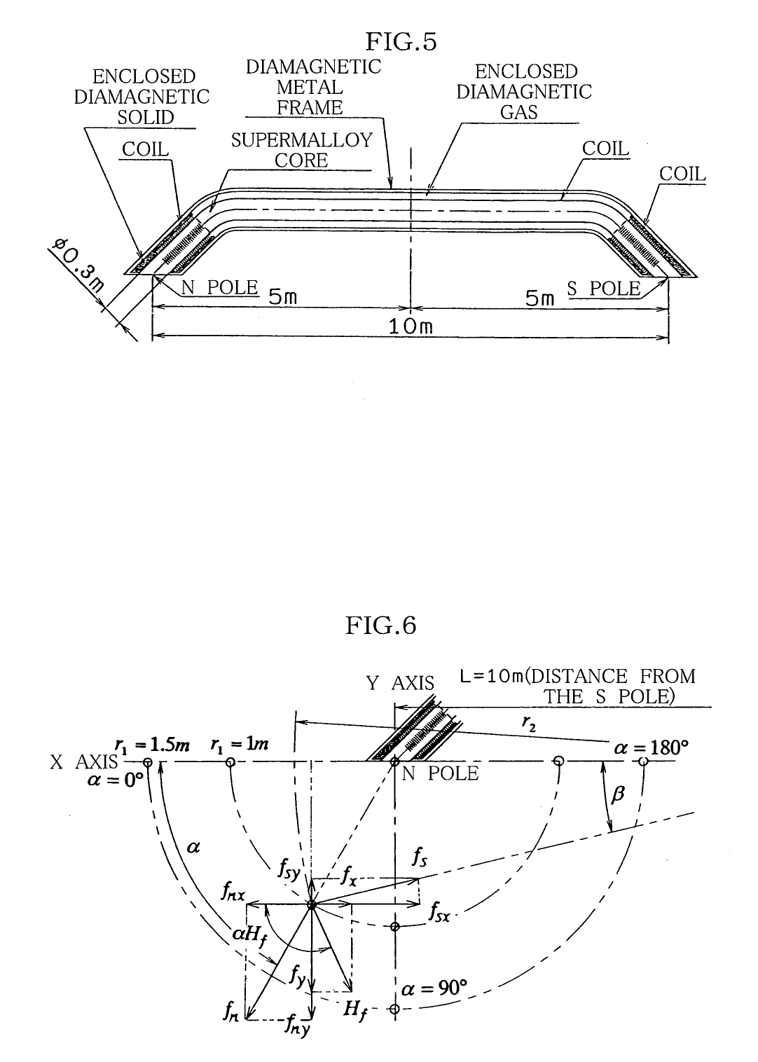

The electromagnet 2a is configured in the manner shown in FIG. 5, and the size of the magnetic poles is calculated in the following manner.

The magnetic flux Φ(Wb) emitted by a magnetic pole is equal to the magnetic pole strength m(Wb) and is calculated as noted below (Formula 6).

$$\begin{matrix}Φ = B \cdot A \\ = μ \cdot H \cdot A \\ = {μ}_{0} \cdot {μ}_{s} \frac{n \cdot i}{l} \times \frac{π \cdot {d}^{2}}{4}\end{matrix} \\ \begin{matrix}B ( Wb ( {m}^{2} ) = magnetic flux density inside the core \\ = μ \cdot H \\ = {μ}_{0} \cdot {μ}_{S} \frac{n \cdot i}{l}\end{matrix} \\ \begin{matrix}μ ( H \text{/} m ) = magnetic permeability of the magnetic material \\ = {μ}_{0} {μ}_{S}\end{matrix} \\ H ( A \text{/} m ) = magnetic field intensity = \frac{n \cdot i}{l} \\ n ( R ) = number of coil windings \\ i ( A ) = electric current \\ l ( m ) = length of the magnetic path \\ \begin{matrix}A ( {m}^{2} ) = cross \text{-} sectional area of the core \\ = \frac{π \cdot {d}^{2}}{4}\end{matrix} \\ d ( m ) = diameter of the core \qquad [ Formula 6 ]$$

The values are determined in the manner described below (Formula 7).

μ₀=4·π×10⁻⁷

μ_{S}=10⁶ (Supermalloy)

n=50000 windings

i=4(A)

l=10(m) [Formula 7]

The magnetic flux Φ is calculated in the following manner (Formula 8) with the aid of formulas 6 and 7 above.

$$\begin{matrix}Φ = 4 \cdot π \times {10}^{- 7} \times {10}^{6} \times \frac{5 \times {10}^{4} \times 4}{10} \times \frac{π \times {0.3}^{2}}{4} \\ = 1776.5 ( Wb )\end{matrix} \qquad [ Formula 8 ]$$

### “8 The Magnetic Field Intensity and the Direction of the Lines of Magnetic Force”

The magnetic field emitted from a point magnetic pole ordinarily spreads out in a spherical and radial fashion in all directions, i.e., 360°, but the upper half of the magnetic poles of the electromagnet 2a configured in the manner shown in FIG. 5 are magnetically sealed, and the magnetic field therefore spreads in a semispherical and radial manner in the downward direction, i.e., 180°.

The magnetic field emitted from the N pole is immediately affected by the S pole, spreads out in a radial fashion while being attracted and bent to the S-pole side, and ultimately reaches the S pole.

The magnetic field intensity and the direction of the lines of magnetic force will be analyzed using vectors as shown in FIG. 6.

The magnetic field intensity H (A/m) is calculated in the following manner (Formula 9).

$$From the expression \\ H = k \frac{m}{{r}^{2}} \\ \begin{matrix}{H}_{f} = {f}_{n} - {f}_{s} \\ = k \frac{m}{{r}_{1}^{2}} - k \frac{m}{{r}_{2}^{2}}\end{matrix} \\ \begin{matrix}∴ {H}_{f} = \sqrt{{f}_{x}^{2} + {f}_{y}^{2}} \\ = \sqrt{{( {f}_{nx} - {f}_{sx} )}^{2} + {( {f}_{ny} - {f}_{sy} )}^{2}} \\ = \sqrt{\begin{matrix}{( k \frac{m}{{r}_{1}^{2}} cos α - k \frac{m}{{r}_{2}^{2}} cos β )}^{2} + \\ {( k \frac{m}{{r}_{1}^{2}} sin α - k \frac{m}{{r}_{2}^{2}} sin β )}^{2}\end{matrix}}\end{matrix} \\ m ( Wb ) = strength of the magnetic poles \begin{matrix}k ( absolute number ) = proportionality constant in \\ a vacuum \\ = 6.33 \times {10}^{4}\end{matrix} \\ \frac{6.33 \times {10}^{4}}{{μ}_{S}} in a substance \\ L ( m ) = distance between poles \\ r ( m ) = distance from point magnetic pole \\ {f}_{n} ( N ) = repulsive force from the N pole \\ {f}_{s} ( N ) = attractive force from the S pole \\ {r}_{1} ( m ) = distance from the N pole \\ {r}_{2} ( m ) = distance from the S pole \\ {f}_{x} ( N ) = {f}_{nx} - {f}_{sx} \\ {f}_{nx} ( N ) = component of {f}_{n} in the X direction \\ {f}_{sx} ( N ) = component of {f}_{s} in the X direction \qquad [ Formula 9 ]$$

The angle (in the direction of the lines of magnetic force) aH_{f} of H_{f} is calculated in the following manner (Formula 10).

$$α {H}_{f} = 90 ° + {cos}^{- 1} \frac{{f}_{y}}{{H}_{f}} \\ {r}_{2} = \sqrt{{( L + {r}_{1} \cdot cos α )}^{2} + {( {r}_{1} \cdot sin α )}^{2}} \\ β = {tan}^{- 1} ( \frac{{r}_{1} \cdot sin α}{L + {r}_{1} \cdot cos α} ) \qquad [ Formula 10 ]$$

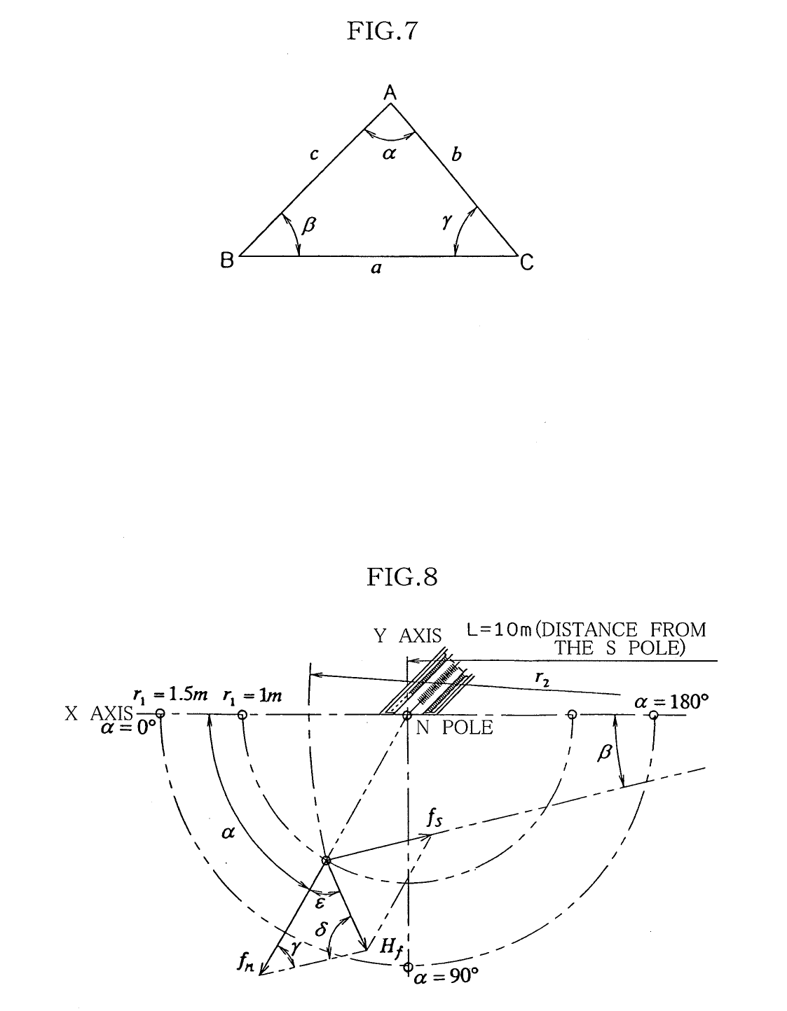

Since the equation above is somewhat complicated, an analysis will be made using sine and cosine rules for a triangle on the basis of FIG. 7.

In FIG. 7, the cosine rule of a triangle is expressed in the following formula (Formula 11).

a²=b²+c²−2·b·c·cos α [Formula 11]

In FIG. 7, the sine rule of a triangle is expressed in the following formula (Formula 12)

$$\frac{a}{sin α} = \frac{b}{sin β} = \frac{c}{sin γ} \qquad [ Formula 12 ]$$

The sine and cosine rules of a triangle are used to make an analysis as shown in FIG. 8, wherein H_{f} is expressed in the following manner (Formula 13) using the cosine rule of a triangle (Formula 11).

H_{f}=\sqrt{fₙ²+fₛ²−2·fₙ·fₛ·cos γ} [Formula 13]

The angle αH_{f} (°) of H_{f} is expressed in the following manner (Formula 14) using the sine rule (Formula 12) of a triangle.

$$\begin{matrix}α {H}_{f} = α + ɛ \\ = α + ( {sin}^{- 1} ( \frac{{f}_{s}}{{H}_{f}} sin γ ) )\end{matrix} \qquad [ Formula 14 ]$$

The numerical values are as noted below (Formula 15).

$$γ = α - β \\ \frac{{H}_{f}}{sin γ} = \frac{{f}_{n}}{sin δ} = \frac{{f}_{s}}{sin ɛ} \\ sin ɛ = \frac{{f}_{s}}{{H}_{f}} sin γ \\ ∴ ɛ = {sin}^{- 1} ( \frac{{f}_{s}}{{H}_{f}} sin γ ) \qquad [ Formula 15 ]$$

### “9 Surface Area of a Magnetic Field”

FIG. 9 is obtained when these formulas are inputted into a spreadsheet function of a computer, calculations are made up to the distance at which a balance is achieved between the intensity of the magnetic field A produced by the electromagnet 2a and the geomagnetic uniform magnetic field B (H=48.4 (A/m)).

The line graph of FIG. 9 is a plot of the position of H=48.4 (A/m) when the magnetic field A emitted from the two poles spreads without limit, wherein the magnetic field A produced by the electromagnet 2a in a certain space is present alone, but if the uniform magnetic field B is present outside this range, the discussion will not be exactly the same.

The internal magnetic field A, whose destination is inhibited by the external uniform magnetic field B, sequentially surpasses the point A from the N pole side and must move toward the S pole while compressing the internal magnetic field A, and therefore results in a shape that rapidly bulges to the downward side of point A.

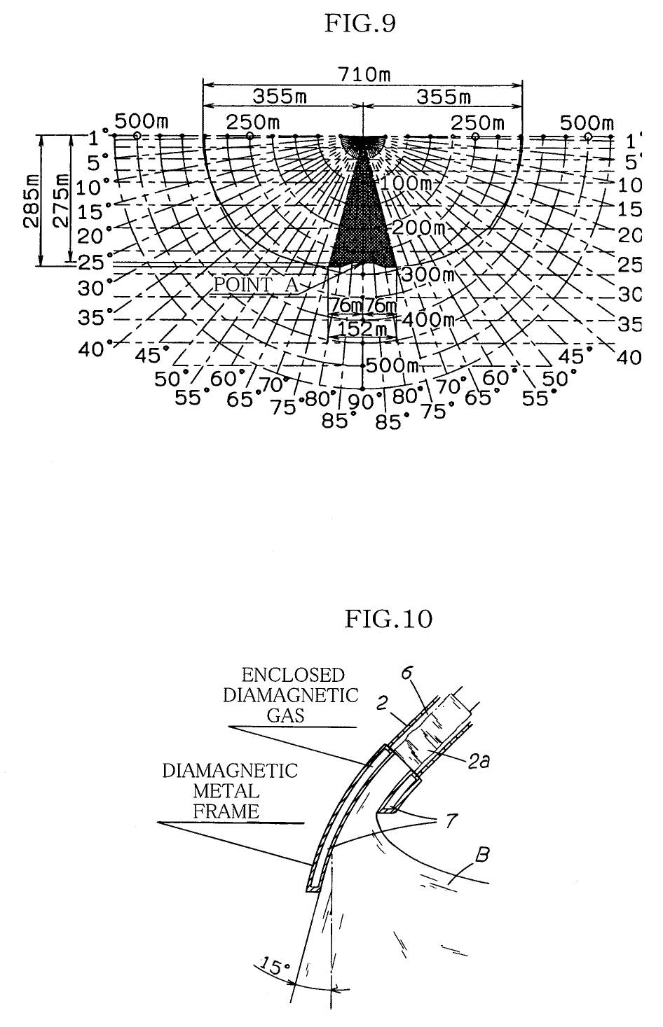

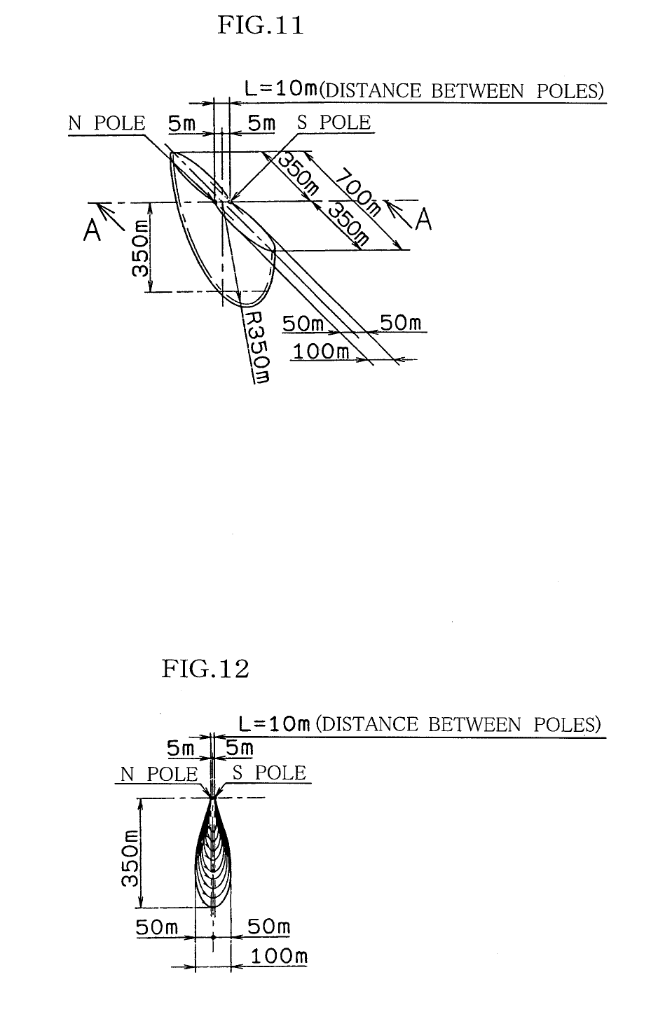

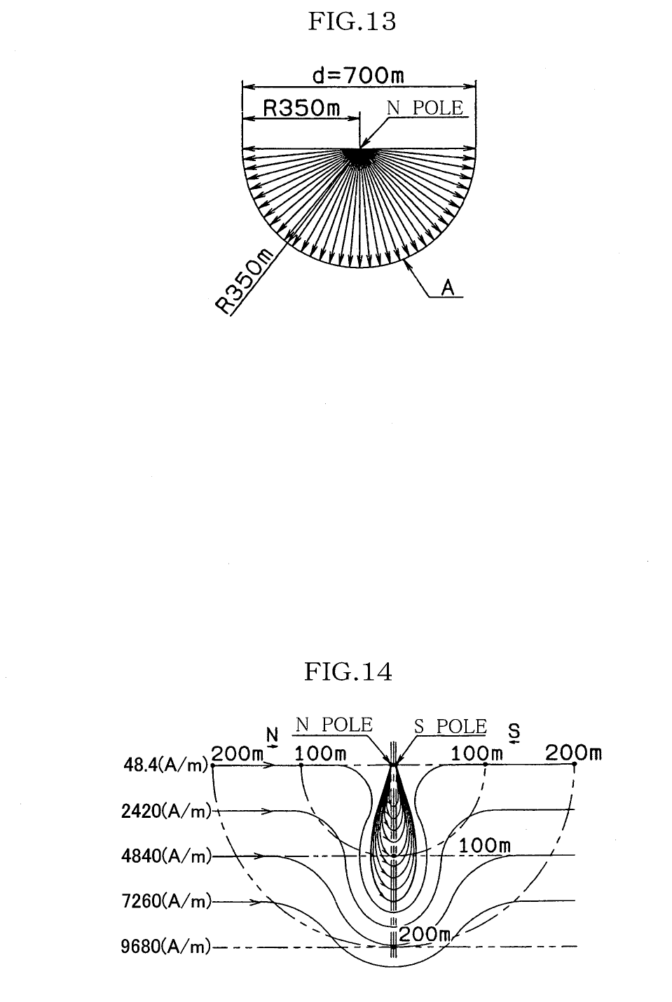

The reason for this will be described later, but the shape of the internal magnetic field A must be extended downward and in as flat a manner as possible. A skirt and nozzles 7 for rectifying the magnetic field A are therefore mounted directly below the magnetic poles as shown in FIG. 10 so as to control the shape thereof. The magnetic field A emitted from the N pole is somewhat oriented downward by the nozzles 7, and the magnetic field A emitted from the nozzles 7 is inhibited by the skirt from spreading in a radial manner to the exterior, must advance so as to follow the surface on the inner side of the skirt, and is at the same time caused to progress directly downward while being subjected to a strong attraction force from the magnetic field on the S pole side and attempting to bend inward. In this manner, the magnetic field A is emitted downward at 75°, whereby an internal magnetic field A space is produced until the magnetic field A emitted from the N pole reaches the S pole in the manner indicated by FIG. 11, as viewed three-dimensionally in the geomagnetic uniform magnetic field B (H=48.4 (A/m)). FIG. 11 is a three-dimensional shape in which the shape in FIG. 12 has been rotated 90° to the left and right about the center of the N and S poles. FIG. 12 is a view of the cross section A-A of FIG. 11. FIG. 13 is a side view depicting an acting surface of the Lorentz force produced by the magnetic poles, and is used for making a comparison of the magnitude and the acting surface of the Lorentz force produced by an electric wire. The Lorentz force has an effect because the magnetic field A is also a spiral magnetic field produced by electric current.

The surface area A(m²) is calculated in the following manner (Formula 16).

$$A = \frac{1}{2} \times \frac{π \cdot {d}^{2}}{4} = \frac{π \times {700}^{2}}{8} = 192423 ( {m}^{2} ) \qquad [ Formula 16 ]$$

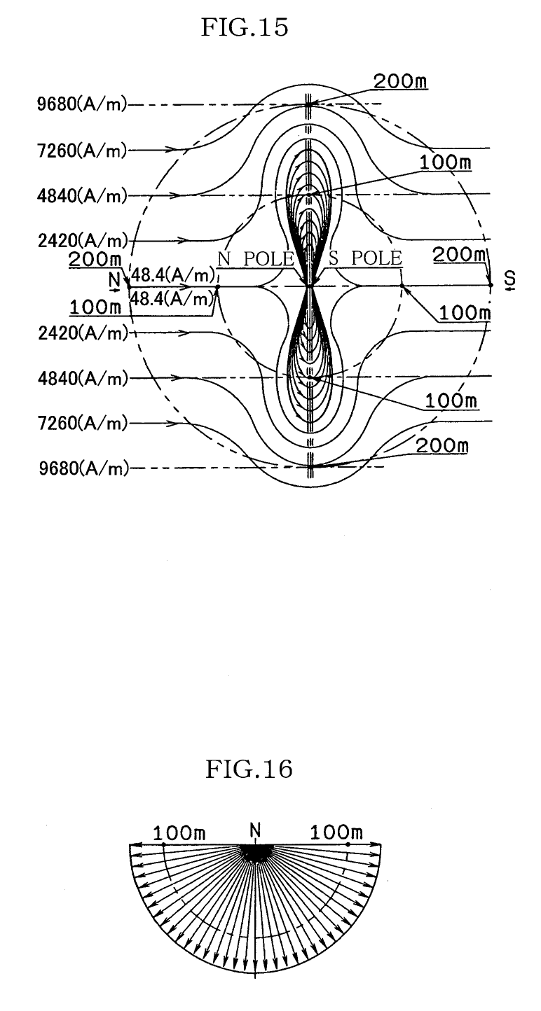

FIGS. 14, 15, and 16 are obtained by combining the intensities of the two magnetic fields A and B, i.e., the internal magnetic field A space produced by the magnetic poles and the geomagnetic uniform magnetic field B (H=48.4 (A/m), at the balancing point of the fields.

The internal magnetic field A space is pressed upward from the congested uniform magnetic field B, the size of the magnetic field A is markedly reduced, and the intensity of the magnetic field is increased.

### “10 Magnitude of the Buoyancy”

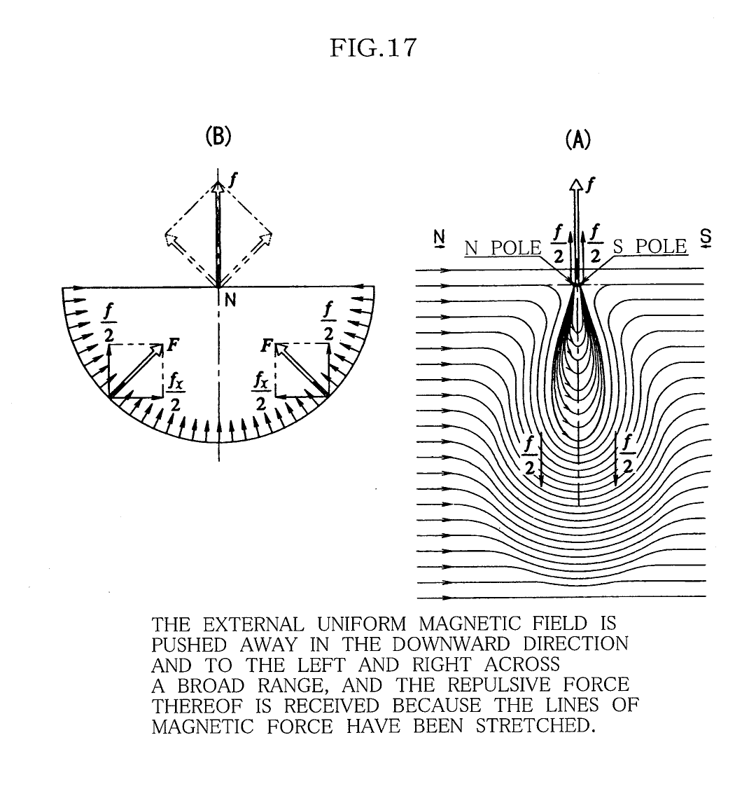

In FIG. 14, the space of the internal magnetic field A produced by the magnetic poles pushes downward on the uniform magnetic field B (H=48.4 (A/m)) and depresses the surface integral of FIG. 13 in the same manner as described in the section titled “5 Lorentz force” where the acting surface of the Lorentz force produced by the electric wire pulls down and depresses the uniform magnetic field B. Therefore, the magnetic field on the lower side is congested, combined, and intensified as shown in FIG. 14, the internal magnetic field A space produced by the magnetic poles is pressed upward in an effort to return to the original uniform magnetic field B, a buoyant force of f/2 is generated in each of the magnetic N and S poles in the manner shown in FIG. 17, and a buoyant force f is generated as a resultant force.

The magnitude of the buoyant force f is a comparison of the size of the surface area and “6 Surface area of the acting surface for the electric wire to achieve a buoyancy of Lorentz force of 1(N) from a geomagnetic uniform magnetic field B (H=48.4 (A/m)).”

However, at this point, the lines of magnetic force of the acting surface that allows the electric wire to obtain the buoyant force of the Lorentz force f=1 (N) from the geomagnetic uniform magnetic field B (H=48.4 (A/m)) are oriented in the downward vertical direction. In contrast, the lines of magnetic force of the acting surface of the Lorentz force of the magnetic field A produced by the magnetic poles is semicircular in the downward direction and spreads in a radial fashion from point N, as shown in FIG. 13. Therefore, in order to make a comparison of the size with the surface area of the acting surface of the lines of magnetic force of the electric wire, a comparison must be made using only the vertical direction component of the surface area of the lines of magnetic force produced by the magnetic poles of FIG. 13.

The vertical direction component is half of the surface area of the semicircle, and the buoyant force f (N) of the Lorentz force that the internal magnetic field A space receives from the uniform magnetic field B is calculated in the following manner (Formula 17).

$$\begin{matrix}f = \frac{1}{2} \times \frac{A}{a} \\ = \frac{192423}{2 \times 108.2} \\ = 889 ( N )\end{matrix} \qquad [ Formula 17 ]$$

A(m²)=area of the acting surface of the Lorentz force of the magnetic field produced by the magnetic poles
a(m²)=area of the acting surface for obtaining a Lorentz force f=1(N) of the magnetic field produced by the electric wire

### (Part 2: The Mechanism of Increasing Buoyancy and the Magnitude of Generated Lift Force)

### “11 Wing Rotors 2”

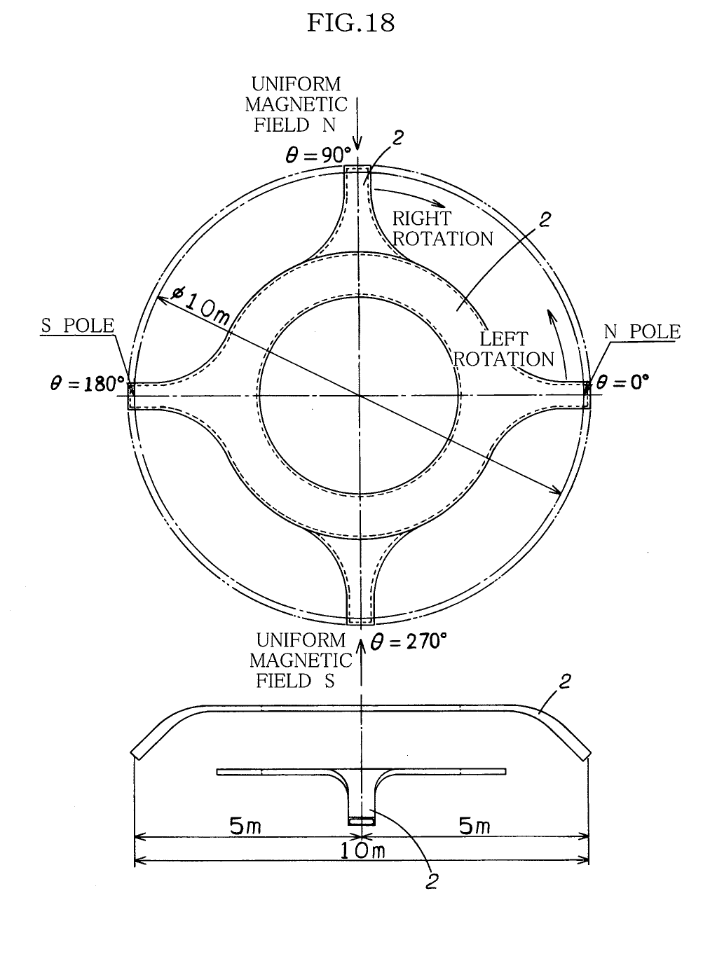

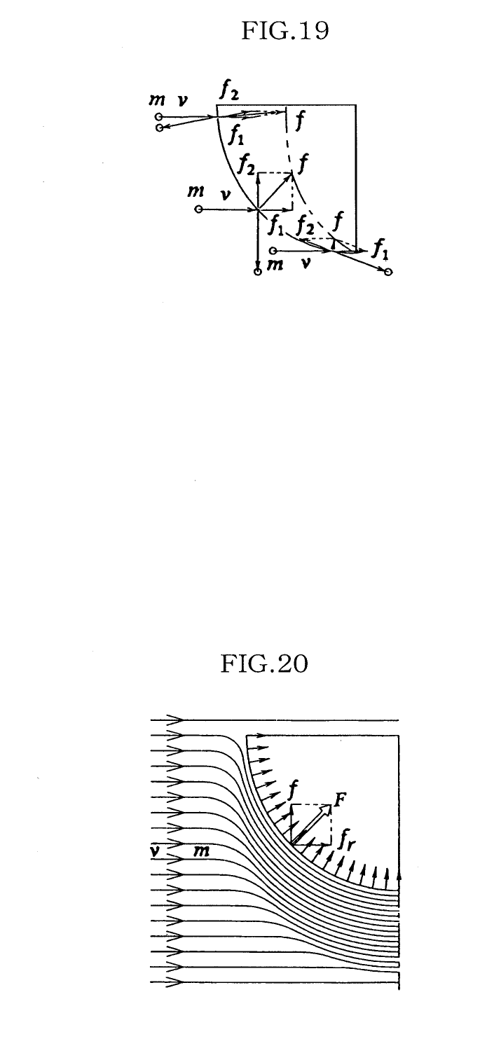

The electromagnets 2a shown in FIG. 5 are disposed in upper and lower levels in the manner shown in FIG. 18 and are configured so that the upper level can rotate leftward and the lower level can rotate rightward about the center of the point O as viewed from above, and so that the upper and lower levels rotate at the same rotational speed. The rotational speed and the rate of electric current are adjustably configured. These levels are hereinafter referred to as “wing rotors 2.”

In FIG. 18, the 90° side of the wing rotors 2 is oriented to the south side angle of inclination (magnetic south pole).

### (A) The Rotation Cycle of the Upper Wing Rotor 2

(1) Rotation starts with leftward rotation from θ=0°, electric current is sent when θ=0°, and the N lines of magnetic force are emitted from the magnetic pole on the 0° side and the S lines of magnetic force are emitted from the magnetic pole on the 180° side.
(2) The wing rotors continue to rotate for 90° and then the electric current to the coils is stopped.
(3) The wing rotors continue rotate for 90°, electric current is sent in the opposite direction to the coils when θ=180°, the S lines of magnetic force are emitted from the magnetic pole on the 180° side, and the N lines of magnetic force are emitted from the magnetic pole on the 0° side.
(4) The wing rotors continue to rotate for 90° and then the electric current to the coils is stopped when θ=270°.
(5) The wing rotors continue to rotate for 90° until θ=0°.

This completes a single cycle of the rotation of the upper wing rotor 2.

### (B) The Rotation Cycle of the Lower Wing Rotor 2

(1) When the upper wing rotor 2 begins leftward rotation from θ=0°, the lower wing rotor 2 begins rightward rotation at the same time from θ=270°.

(2) The wing rotors continue to rotate 90° and electric current is sent when θ=180°, and the N lines of magnetic force are emitted from the magnetic pole on the 180° side and the S lines of magnetic force are emitted from the magnetic pole on the 0° side.
(3) The wing rotors continue to rotate for 90° and then the electric current to the coils is stopped when θ=90°.
(4) The wing rotors continue rotate for 90°, electric current is sent in the opposite direction to the coils when θ=0°, the N lines of magnetic force are emitted from the magnetic pole on the 180° side, the S lines of magnetic force are emitted from the magnetic pole on the 0° side, and rotation continues until θ=270°.

### “12 Collision Between a Wall and an Object”

### (1) Collision Between a Wall and an Object

In FIG. 19, when an object collides with a semicircular wall, a force of f₁ operates on the wall at an incident angle from the object, a force of f₂ operates from the angle of reflection, and a force f is generated by the combined forces of f₁ and f₂.

The magnitude f(N) of the force is f=m·v.

The numerical values are calculated in the manner noted below (Formula 18).

m(kg^{f})=mass of the object

v(m/s)=velocity of the object [Formula 18]

The magnitude and angle of the force f are different for collisions with any surface, and are oriented toward the center of the arc of the wall surface.

### (2) Collision Between a Wall and a Jet Flow

In FIG. 20, a force f(N) received by a wall when a jet flow collides with an arcuate wall is also f=m·v, and the same process occurs when an object collides with an arcuate wall.

The numerical values are calculated in the manner noted below (Formula 19).

m(kg^{f})=mass of the object

ν(m/s)=velocity of the object [Formula 19]

### (3) Lines of Magnetic Force of a Uniform Magnetic Field B Stretched by a Lorentz Force

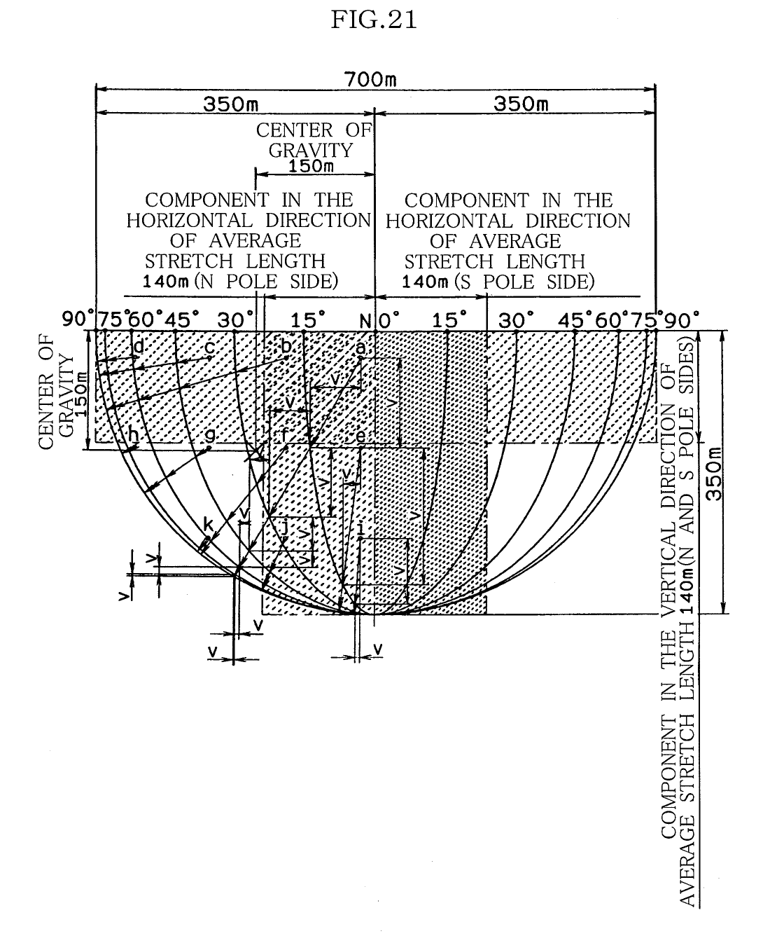

Here, when the wing rotors 2 are rotated as described in the section titled “11 Wing rotors 2,” the lobes of the plane of the Lorentz force as viewed from the N pole side gradually spread and increase from θ=0° in the lateral direction. The lobes continue to widen until θ=90°, and the lines of magnetic force of the uniform magnetic field B that interact with the surfaces thereof are sequentially drawn diagonally downward and made to move around the object. Therefore, the lines of magnetic force are stretched in the vertical and horizontal directions. For example, in FIG. 21, there are lines of magnetic force that advance from N to S through point a. The lines are interrupted by the plane of the Lorentz force, the lines are drawn out at a velocity commensurate with the length of ν in the vertical and horizontal directions when a 15° rotation is made at 15°, and the distance is increased by a commensurate amount. The lines must advance to S after having moved around on the opposite side in the same manner. The lines of magnetic force that pass through any of the points a, b, c, d, e, f, g, h, i, and j at 30°, 45°, or even 90° are stretched at a velocity commensurate with the length ν and must advance to S after having moved around the object by a commensurate distance. In FIG. 21, the plane of the Lorentz force rotates 90°, the lines of the uniform magnetic field B are drawn out by an average stretch length of 1 (m) and an average stretch velocity ν(m/s), and the repulsive force is then imparted.

In this case as well, the magnitude f(N) of the repulsive force thus generated is f=m·ν=m_{f}·νₐ. These numerical values are calculated in the manner noted below (Formula 20).

m_{f}(kg^{f})=buoyancy of the Lorentz force

νₐ(m/s)=average stretch velocity of the lines of magnetic force [Formula 20]

(4) Buoyancy Produced when the Plane of the Lorentz Force Stretches the Lines of Magnetic Force of a Uniform Magnetic Field B

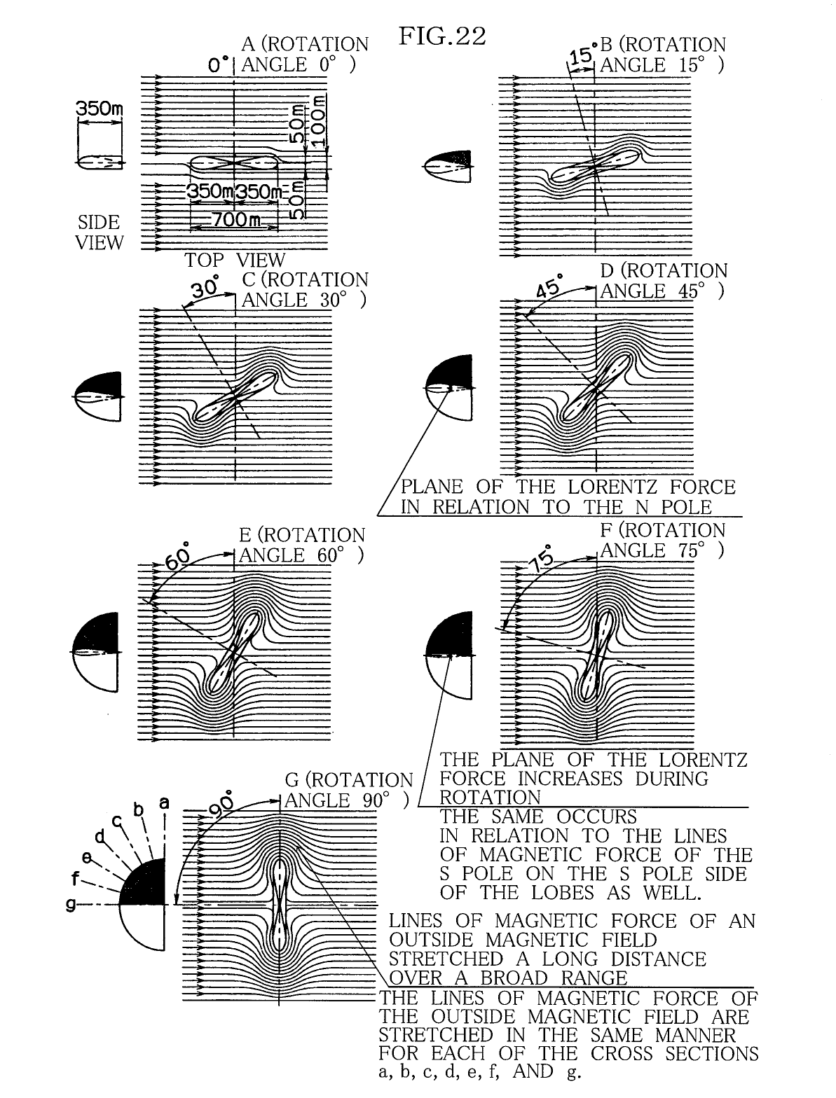

The term m_{f} is 0 when θ=0°, and is a force that gradually increases as θ rotates. As shown in FIGS. 17 and 22-G, a single plane remains and does not disappear when rotation stops at θ=90°.

The term νₐ shows that movement increases in the vicinity of θ=0° and that movement slows when θ increases as a result of rotation.

Therefore, the buoyant force f (N) produced when the plane of the Lorentz force stretches the lines of magnetic force of the uniform magnetic field B in the downward direction is f=m_{f}·sin θ+(m_{f}·sin θ×νₐ·cos θ), when the S and N pole sides are considered together. These numerical values are calculated in the manner noted below (Formula 21).

m_{f}(Kg^{f})=buoyancy of the Lorentz force

νₐ(m/s)=average stretch velocity of the lines of magnetic force [Formula 21]

(5) Rotational Repulsive Force when the Plane of the Lorentz Force Stretches the Lines of Magnetic Force of a Uniform Magnetic Field B

When the plane of the Lorentz force has rotated 0° to 90°, a rotational repulsive force fᵣ(N) is imparted because the wall of the uniform magnetic field B is pushed along. In such a state, the entire surface area m_{f}(N) of the plane of the Lorentz force pushes the wall of the uniform magnetic field B at a rotational speed νₐ (m/s) in the front side plane in the rotational direction of the respective poles, and in the rear side plane in the rotational direction; and the entire surface area m_{f}(N) of the plane of the Lorentz force is drawn away from the wall of the uniform magnetic field B at a rotational speed −νₐ (m/s) and is caused to generate a negative pressure. Therefore, the entire plane of the Lorentz force becomes a rotational repulsive force.

Therefore, the rotational repulsive force fᵣ(N) that operates on a single magnetic pole on each of the S pole side and N pole side is fᵣ=m_{f}·sin θ×νₐ·cos θ. These numerical values are calculated in the manner noted below (Formula 22).

m_{f}(kg^{f})=buoyancy of the Lorentz force

v_{B}(m/s)=rotational speed of the plane of the Lorentz force [Formula 22]

(6) Average Stretch Velocity of the Lines of Magnetic Force of the Uniform Magnetic Field B

Here, the magnitude of the average stretch velocity νₐ of the lines of magnetic force of the uniform magnetic field B will be considered. In FIG. 21, the surface area of the semicircle is A=192,423 (m²) as determined from previous calculations (Formula 16). The average stretch length l(m) of the lines of magnetic force of the uniform magnetic field B of the vertical direction component alone is half the entire stretch length, and since the same stretch length occurs on the reverse side as well, the length is calculated in the manner noted below (Formula 23).

$$\begin{matrix}l = \frac{1}{2} \times 2 \times \frac{A}{d} \\ = \frac{192423}{700} \\ = 275 ( m )\end{matrix} \qquad [ Formula 23 ]$$

The numerical values are calculated in the manner noted below (Formula 24).

A(m²)=surface area of a semicircle

d(m)=diameter of a semicircle [Formula 24]

Here, assuming that the time required for the plane of the Lorentz force to rotate 90° is t=0.05 (s), the average stretch velocity νₐ (m/s) of the lines of magnetic force of the uniform magnetic field B is calculated in the following manner (Formula 25).

$$\begin{matrix}{v}_{a} = \frac{l}{t} \\ = \frac{275}{0.05} \\ = 5500 ( m \text{/} s )\end{matrix} \qquad [ Formula 25 ]$$

### (7) Rotational Speed of the Plane of the Lorentz Force

The rotational radius r(m) of the plane of the Lorentz force is 150 (m) from the center of gravity position of FIG. 21.

Here, assuming that the time required for the plane of the Lorentz force to rotate 90° is t=0.05 (s), the rotational velocity νₐ (m/s) of the plane of the Lorentz force is calculated in the following manner (Formula 26).

$$\begin{matrix}{v}_{b} = \frac{π}{2} \times \frac{r}{t} \\ = \frac{π}{2} \times \frac{150}{0.05} \\ = 4712 ( m \text{/} s )\end{matrix} \qquad [ Formula 26 ]$$

The numerical values are calculated in the manner noted below (Formula 27).

$$\frac{π}{2} = rotational angle = 90 ° \qquad [ Formula 27 ]$$

r(m)=rotational radius of the plane of the Lorentz force

t(s)=time required to rotate 90°

The sections titled “(3) Lines of magnetic force of a uniform magnetic field B stretched by the plane of the Lorentz force,” “(4) Buoyancy produced when the plane of the Lorentz force stretches the lines of magnetic force of a uniform magnetic field B,” and “(5) Rotational repulsive force when the plane of the Lorentz force stretches the lines of magnetic force of a uniform magnetic field B” are central to this theory, are the main focus, and are original in concept.

The following facts have been discovered as a result of thoroughgoing research, thought, and insight.

“Buoyancy is a repulsive force produced from the number, direction, length, and velocity with which stretching occurs in the lines of magnetic force of a uniform magnetic field B having H (number) of lines of magnetic force per square meter.”

The properties of the lines of magnetic force are similar to those of a stretched rubber string, and the lines themselves have tension that attempts to contract the lines. Therefore, the magnetic field produced by the electric current is pushed upward, and a buoyant force f is created.

Generally, a motor having a core in an inner rotor rotates by tension that is produced when internally twisted lines of magnetic force are generated, and the lines of magnetic force themselves attempt to contract and become straight. A motor that does not have a core in the inner rotor rotates due to the repulsive force that is produced when the plane of the Lorentz force stretches the lines of magnetic force of a uniform magnetic field B.

A boat that travels through water is buoyed by a buoyant force that is determined by the amount of water that is displaced, and the bow is slightly lifted, depending on the structure thereof, by the water pressure, and the stern slightly sinks due to the negative pressure.

The flapping of wings by butterflies, dragonflies, and birds also produces a buoyant force that is produced by the collision of a fluid and a wall.

Propulsion and buoyant force is generated by force that is produced against a wall when a jet flow collides with a wall in the cylinders of steam engines and internal combustion engines, and in the nozzle of a rocket.

In this manner, the plane of the Lorentz force produced by wing rotors 2 appears instantaneously and is combined with an external magnetic field at the same time, the plane rotates and stretches out the lines of magnetic force of a uniform magnetic field B, and the repulsive force thereof is reliably transmitted to the two magnetic poles for an instant. All of the force disappears without a trace as if nothing had happened, and the surrounding magnetic field is not affected in the least. Next, the same process starts from the opposite direction with opposite rotation.

### “13 Buoyant Force Produced by the Rotations of the Wing Rotors 2”

In FIG. 22, an N magnetic field is emitted from a magnetic pole when the rotational angle of the wing rotors 2 is θ=0°, a planes of the Lorentz force is formed, and the planes=that initially faces sideward begins to rotate while gradually turning in the front direction of the N lines of magnetic force of a uniform magnetic field B. The buoyant force f of the plane of the Lorentz force that is produced by the rotation thereof until θ=90° will be calculated as a typical example when the rotational angle of the upper wing rotors 2 has reached θ=45°.

In this case, if the output rate per second of the wing rotors 2 is 20 (Hz) in order to prevent large vibrations from occurring in the airframe 1, the number of rotations n (rps) per second of the wing rotors 2 is n=20/2×2=5(rps) because two wing rotors 2 provide output twice per single rotation.

The average stretch velocity νₐ (m/s) of the lines of magnetic force of a uniform magnetic field B is νₐ=5,500 (m/s) as found using the calculation formula (Formula 25) described above.

The buoyant force f(N) of the plane of the Lorentz force produced by the rotations of the wing rotors 2 is calculated in the following manner (Formula 28).

$$\begin{matrix}f = {m}_{f} \cdot sin θ + ( {m}_{f} \cdot sin θ \times {v}_{a} \cdot cos θ ) \\ = 889 \times sin 45 ° + ( 889 \times sin 45 ° \times 5500 \times cos 45 ° ) \\ = 2445379 ( N ) \\ = 249528 ( {Kg}^{f} )\end{matrix} \qquad [ Formula 28 ]$$

Note that 1(kg^{f})=9.8(N).

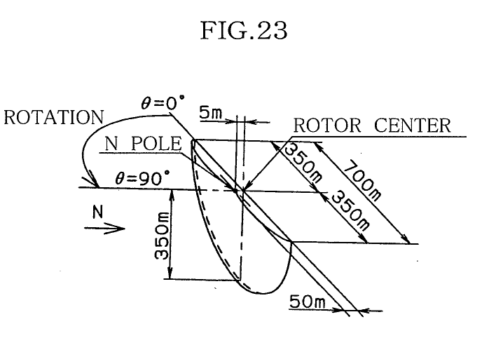

When these formulas are inputted into a spreadsheet function of a computer and f is calculated at each point from θ=0° to θ=90° of the rotational angle of the wing rotors 2 shown in FIG. 23, the maximum buoyant force of f=249,528 (kg^{f}) is obtained when θ=45°, and an average buoyant force of f=150,130 (kg^{f}) is obtained.

### (Part 3: Achieving Magnetic Propulsion Based on the Above Theory)

A specific example of the present invention shall be described below in detail, based on the above magnetic propulsion theory.

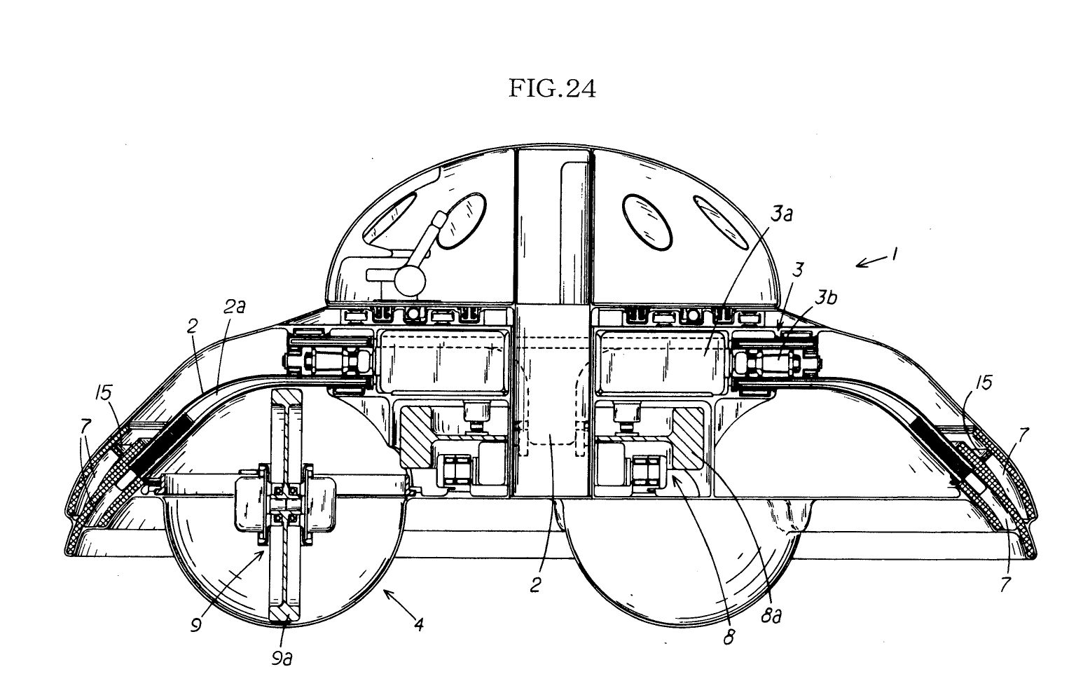

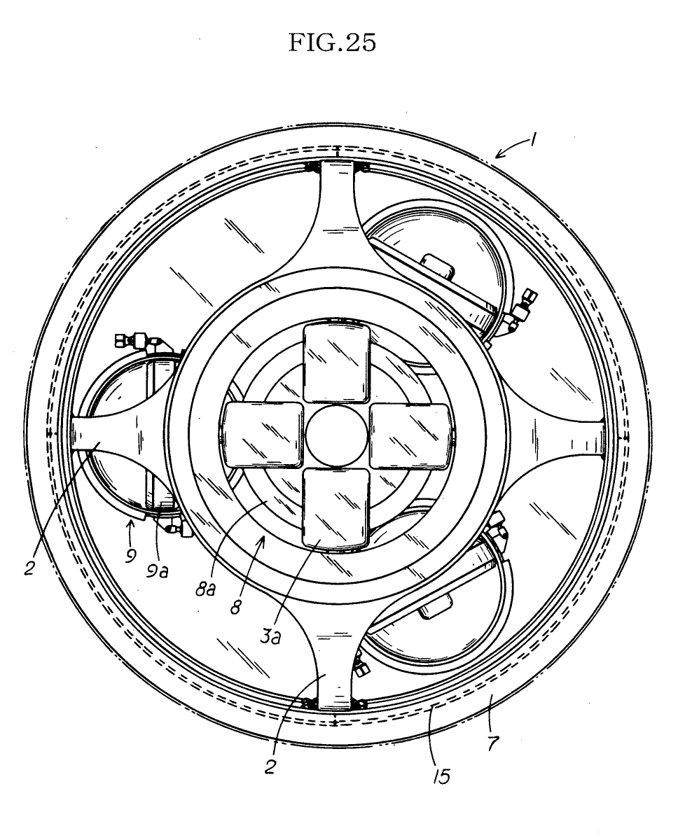

The present example is a magnetic propulsion device, as shown in FIGS. 24 and 25. An airframe 1 is rotatably provided, via an axial rotation mechanism 3, with wing rotors 2. The wing rotors 2 have an electromagnet 2a, and generate a magnetic field A below both magnetic poles of the electromagnet. The upper side of the magnetic poles is magnetically sealed. The direction in which electric current is made to flow to the electromagnet 2a and the amount thereof are adjustable. The direction of magnetic flux of the magnetic field A is reversible. The airframe 1 is held in a state in which horizontal and oblique rotation are prevented. The magnetic field A generated by the wing rotors 2 is able to rotate with respect to a uniform magnetic field B on the exterior of the airframe 1. The rotating of the magnetic field A with respect to the uniform magnetic field B generates a Lorentz force that magnetically propels the airframe 1.

The wing rotors 2 are configured as described below. A magnetic seal part 6 is provided to substantially the entire peripheral surface, including the upper side of both magnetic poles of the electromagnets 2a, which have the configuration of a straight rod having downwardly bent left and right sides. The magnetic seal 6 prevents the magnetic field A from being generated above the magnetic poles of the electromagnets 2a, while allowing the magnetic field A to be generated below the magnetic poles. Specifically, and as shown in FIG. 5, the magnetic seal part 6 (a solid body, metallic frame, and gas made of diamagnetic materials) is used to enclose the region of the electromagnet 2a, which is obtained by winding a wire around a sandwich core body (Supermalloy). The region of the two magnetic poles is left unenclosed. As shown in FIG. 10, the magnetic field A, whose expanding space is restricted downward to a certain degree by the magnetic seal part, is restricted further downward by nozzles 7 (described hereunder), and extends under the axes of the magnetic pole of the electromagnet 2a. The wing rotors 2 have an overall protruding configuration, as shown in FIG. 18, with both ends slantingly extending downward away from the center of the round central region.

The present example is configured so that the wing rotors 2 are provided in at least a single coaxial set, and the axial rotation mechanism 3 is able to cause at least the single set of wing rotors 2 to rotate in mutually opposite directions with respect to the airframe 1. The structure may accommodate more than two wing rotors 2, but according to the preset example, a total of two (upper and lower) are provided, as shown in FIG. 18.

As shown in FIG. 5, the wing rotors 2 have a flux path length l of 10 m, and a core material (Supermalloy) diameter of 0.3 m. The number of wire windings n on the core is 50000, and the current i passed through the wire is set to 4 (A).

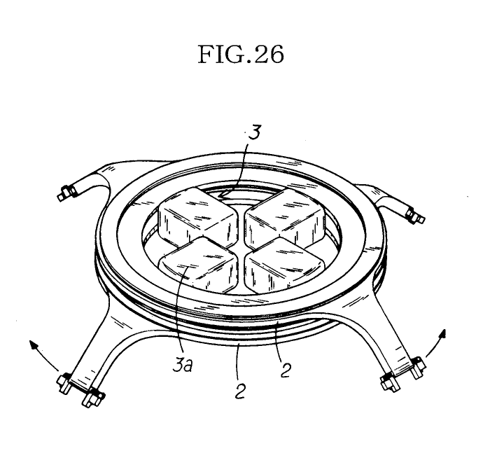

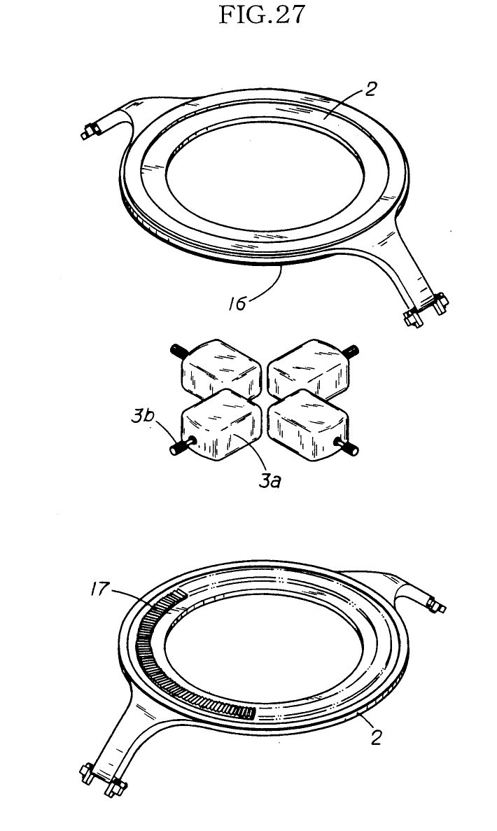

As shown in FIG. 26, the axial rotation mechanism 3 comprises four motors 3a provided to a round, hollow region in the center of the set of coaxially disposed upper and lower wing rotors 2. Four gears 3b that are provided to each of the motors 3a and that rotate at high speed are held from above and below by the set of upper and lower wing rotors 2. The rotation of the gears 3b causes the upper wing rotor 2 to rotate to the left (counterclockwise in FIG. 26) and the lower wing rotor 2 to rotate to the right (clockwise in FIG. 26). The rotation of the gears 3b causes the wing rotors to rotate at the same speed. The common axis of rotation of the upper and lower wing rotors is established in a direction that runs perpendicular to the axes of the magnetic poles of the electromagnets 2a, and is located between the magnetic poles of the electromagnets 2a of the wing rotors 2. According to the present example, the axial rotation mechanism 3 is configured so that the wing rotors 2 rotate five times per second.

FIG. 27, which is an exploded perspective view of FIG. 26, shows the set of coaxially disposed upper and lower wing rotors 2 and the axial rotation mechanism 3. Specifically, the upper part of the gears 3b that are made to rotate by the motors 3a is made to mesh with the drive gear 16, which is peripherally disposed on the bottom surface of the upper wing rotor 2. The lower part of the gears 3b is made to mesh with the drive gear 17, which is peripherally disposed on the top surface of the lower wing rotor 2. The drive force of the motors 3a is transmitted via each of the drive gears 16, 17, and the upper/lower wing rotors 2 are made to rotate in opposite directions.

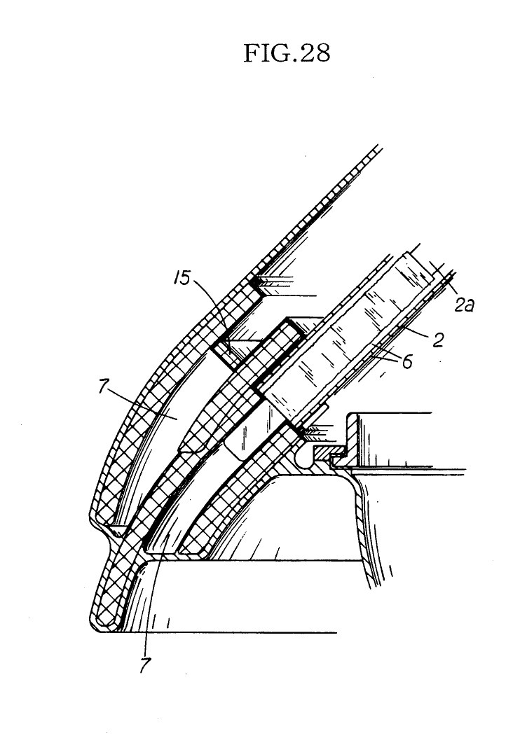

As shown in FIGS. 24 and 28, the airframe 1 or the wing rotors 2 are provided with the nozzles 7, which are used for restricting, in a prescribed direction, the direction of magnetic flux of the magnetic field A generated by the wing rotors 2. Specifically, the nozzles 7, which are made of a diamagnetic material member, are peripherally disposed on the airframe 1 along the rotational trajectory of the magnetic poles of the wing rotors 2, and are positioned proximally with respect to the magnetic poles thereof. A magnetic field space of the magnetic field A generated from the wing rotors 2 is prevented from spreading in the axial direction of the magnetic poles of the wing rotors 2, and the shape of the nozzles 7 is determined so that the magnetic flux direction is restricted in a manner that causes the magnetic field space to spread downward and in a direction orthogonal to axes of the magnetic poles.

Consequently, the magnetic field A, which is generated by the wing rotors 2 and directed downward to a certain degree by the magnetic seal part 6, is directed further downward by the nozzles 7. In addition, as shown in FIG. 10, the nozzles prevent the field from expanding in the direction of the axes of the magnetic poles of the wing rotors 2. As shown in FIGS. 11 and 12, the direction of magnetic flux is restricted (biased) so that the magnetic field A will extend downward and in a direction perpendicular to the axes of the magnetic poles of the wing rotors 2, and will form a semicircular magnetic space in terms of overall shape. The nozzles 7 may be provided to the wing rotors 2, and configured so as to automatically rotate integrally therewith.

However, according to the present example, when a current is simultaneously passed through the electromagnets 2a of the set of upper and lower wing rotors 2 that are rotating in mutually opposite directions, the forces of repulsion and attraction acting between the magnetic poles of the wing rotors 2 will inevitably, and effectively, prevent the wing rotors 2 from rotating about an axis thereof. Therefore, the present example is configured so that a current will be passed in an alternating fashion (every 90° of rotation) to one or the other of the set of upper and lower wing rotors 2 rotating at the same rate in mutually different directions.

In order to control the current, as has been described above, the wing rotors 2 have a zone where current flows (e.g., a range of 0 to 90° and 180 to 270° in the case of the upper wing rotor) and a zone where no current flows (e.g., a range of 90 to 180° and 270 to 0° in the case of the upper wing rotor). As shown in FIG. 28, a shielding plate 15 comprising a diamagnetic material is provided within the nozzles 7 on the wing rotors 2 in the zone where no current flows. The shielding plate 15 prevents the magnetic field lines from penetrating. The wing rotor 2 through which no current is passing will not be affected by the magnetic field A generated by the other wing rotor 2.

As will only happen when the magnetic poles of the set of upper and lower of wing rotors 2 are out of phase, electricity will also be delivered to the wing rotor 2 through which no current is passing, a small magnetic field will be generated at the same pole, and the magnetic poles of both wing rotors 2 will be reliably prevented from being drawn together.

As shown in the drawings, reference symbol 8 indicates a main gyro for controlling oblique rotation of the airframe 1, and reference symbol 9 indicate a sub-gyro for controlling the horizontal rotation of the airframe 1.

The main gyro 8 comprises a gyro 8a capable of rotating around three intersecting axes, and is constituted so that the rotation of the gyro 8a will generate a gyro moment that cancels out an external moment imparted to the airframe 1 in the direction of oblique rotation.

The sub-gyro 9 comprises a gyro 9a capable of rotating around three intersecting axes, and is constituted so that the rotation of the gyro 9a generates a gyro moment that cancels out the external moment imparted to the airframe 1 in the direction of horizontal rotation.

Specifically, when the magnetic field A generated by the wing rotors 2 of the airframe 1 is made to rotate with respect to the uniform magnetic field B, the magnetic field A will impart a rotational reflective force from the uniform magnetic field B, and an external moment that causes the airframe 1 to rotate horizontally or obliquely will be imparted to the airframe 1. However, the gyro moments of the main gyro 8 and the sub-gyro 9 will offset the external moment, and the airframe 1 will be able to be held in a state wherein horizontal and oblique rotation is prevented. The horizontal and oblique rotation of the airframe 1 can also be controlled by controlling the gyros 8a, 9a.

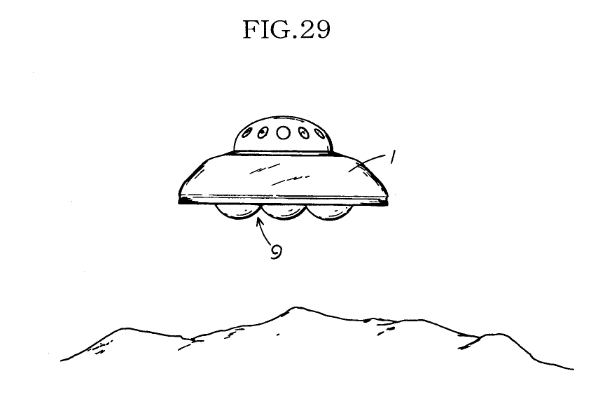

The present example is configured as described above. Therefore, in space having a geomagnetism (uniform magnetic field B) where the intensity of the magnetic field is H=48.4 (A/m), the airframe 1 will be held stably in a prescribed stationary attitude, as shown in FIG. 29, and the magnetic field A generated by the wing rotors 2 will be made to rotate with respect to the geomagnetism (uniform magnetic field B). As a result, according to the magnetic propulsion theory described above, a magnetic propulsive force equating to an average buoyancy (upward magnetic propulsive force) of f=150130 kg^{f} will be generated as long as, e.g., the airframe 1 is in a horizontal direction relative to the direction of flux of the uniform magnetic field B. This will cause the airframe 1 to be propelled magnetically. In addition, the airframe 1 can automatically be propelled magnetically in a prescribed direction by being oriented in the desired direction.

Accordingly, the present example results in a highly innovative and exceptionally useful magnetic propulsion device. The device is able to provide magnetic propulsion in any desired direction above the earth where geomagnetism is present, as shall be apparent, but also in outer space where the magnetic field produced by celestial bodies is present, or in other areas of space where a uniform magnetic field B is present.

What is claimed is:

1. A magnetic propulsion device, wherein
a wing rotor, which has an electromagnet and which generates a magnetic field toward a lower side of both of two magnetic poles of the electromagnet while an upper side of both magnetic poles is magnetically sealed, are provided to an airframe in an axially rotatable manner via an axial rotation mechanism;
the amount and direction of electric current flowing to the electromagnet are adjustable;
the magnetic flux direction of the magnetic field is reversible;
the airframe is held in a state in which horizontal rotation is restrained;
the magnetic field generated by the wing rotors is able to rotate with respect to a uniform magnetic field on an exterior of the airframe; and
the rotation of the magnetic field in relation to the uniform magnetic field generates a Lorentz force that magnetically propels the airframe.

2. The magnetic propulsion device according to claim 1, wherein
nozzles whereby the direction of the magnetic flux of a magnetic field generated from the wing rotors is restricted to a prescribed direction are provided to the wing rotors or the airframe;
a magnetic field space of the magnetic field generated by the wing rotors is prevented from spreading in the axial direction of the magnetic poles of the wing rotors; and
the shape of the nozzles is determined so that the magnetic flux direction is restricted in a manner that causes the magnetic field space to spread downward and in a direction orthogonal to axes of the magnetic poles.

3. The magnetic propulsion device according to claim 1 or 2, wherein
at least a single set of the wing rotors is coaxially provided to the airframe; and
at least the single set of wing rotors is configured to be capable of axial rotation in mutually opposite directions with respect to the airframe via an axial rotation mechanism.

4. The magnetic propulsion device according to claim 1 or 2, wherein the electric current that flows to the electromagnet of the wing rotor is controlled when flowing to the electromagnet so that the magnetic pole that rotates toward the N pole direction of the uniform magnetic field on the exterior of the airframe is an N pole, and the magnetic pole that rotates toward the S pole direction is an S pole.

5. The magnetic propulsion device according to claim 3, wherein the electric current that flows to the electromagnet of the wing rotor is controlled when flowing to the electromagnet so that the magnetic pole that rotates toward the N pole direction of the uniform magnetic field on the exterior of the airframe is an N pole, and the magnetic pole that rotates toward the S pole direction is an S pole.
